(19) United States
(12) Patent Application Publication
(10) Pub. No.: US 2022/0148090 A1
(43) Pub. Date: May 12, 2022

(54) FINANCIAL INSTRUMENT COMPOSITION VISUALIZATION TOOL

(71) Applicant: FUNDLAB TECHNOLOGIES INC., Pointe-Claire (CA)

(72) Inventors: John EVANGELIOU, Kirkland (CA); George EVANGELIOU, Kirkland (CA)

(21) Appl. No.: 17/431,905

(22) PCT Filed: Feb. 21, 2020
(86) PCT No.: PCT/CA2020/050225

§ 371 Date: Aug. 18, 2021

Related U.S. Application Data
(60) Provisional application No. 62/808,983, filed on Feb. 22, 2019.

(51) Int. Cl. G06Q 40/06; G06T 11/20; G06T 11/40

(52) U.S. Cl. CPC G06Q 40/06; G06T 11/40; G06T 11/206

(57) ABSTRACT

Systems and methods for visualizing investments are provided. An investment visualization tool includes a group of a plurality of entries associated with a first asset class. The group includes at least two subgroups associated with respective market characteristics. The group also includes a plurality of entries, each displaying a respective identifier and/or a respective numerical value. The entries are each disposed in one of the at least two subgroups, share a common visual characteristic associated with each subgroup, and are disposed substantially contiguously within the subgroups.

### TECHNICAL FIELD

The present disclosure relates to financial tools, and more specifically to digital financial tools for visualizing the composition of financial instruments.

### BACKGROUND OF THE ART

Whether shopping for financial instruments in which to invest or reviewing an existing financial portfolio, evaluating the composition of complex financial instruments, such as mutual funds, can be a difficult exercise. Information is often disparately located, presented in the form of lengthy prospectus documents, or provided with too few, or too many, subdivisions and/or characterizing information.

In particular, existing approaches for displaying information about financial instruments consist primarily of static tools, such as paper pamphlets or prospectus, which are often difficult to read and understand. Additionally, it is not uncommon for certain information, such as share class, to be omitted from such static financial tools, requiring that investors find this information elsewhere, for example via webpages. Often this leads to investors not having adequate information when making investment decisions, and the time required to collect sufficient information leaves prospective investors frustrated.

In addition, there are challenges facing investors seeking to identify financial instruments which meet specific criteria: there are few centralized repositories of financial instruments, and most search tools are limited to searching by name, category, or other qualitative characteristics.

Therefore, there is room for improved financial tools.

### SUMMARY

In accordance with a broad aspect, there is provided an investment visualization tool. The investment visualization tool comprises a first group associated with a first asset class, and a second group associated with a second asset class, the second group being laterally spaced from the first group. The first group comprises at least two first subgroups associated with respective first market characteristics. The first group also comprises a plurality of first entries each displaying a respective first identifier and/or a respective first numerical value, the first entries each being disposed in one of the at least two first subgroups, sharing a first common visual characteristic associated with each first subgroup, and disposed substantially contiguously within the first subgroups. The second group comprises at least two second subgroups associated with respective second market characteristics. The second group also comprises a plurality of second entries each displaying a respective second identifier and/or a respective second numerical value, the second entries each being disposed in one of the at least two second subgroups, sharing a second common visual characteristic associated with each second subgroup, and disposed substantially contiguously within the second subgroups.

The investment visualization tool as defined herein may also include, in whole or in part, and in any combination, one or more of the following additional elements.

In at least some embodiments, the investment visualization tool further comprises a third group representative of a plurality of asset classes comprising the first and second asset classes, the third group comprising a plurality of third entries each displaying a respective third identifier and a respective third numerical value, the third entries disposed substantially contiguously and spaced from the first and second groups, the third entries sharing a third common visual characteristic distinct from the first and second common visual characteristics.

In at least some embodiments, the plurality of asset classes comprises fixed income assets, equity assets, cash assets, and alternative assets.

In at least some embodiments, at least some of the third entries are expandable to reveal a plurality of additional entries each displaying at least one of a respective additional identifier and a respective additional numerical value and associated with a respective additional market characteristic distinct from the first and second market characteristics.

In at least some embodiments, at least some of the first subgroups and second subgroups are associated with common market characteristics.

In at least some embodiments, each of the first and second common visual characteristics comprises a respective colour element.

In at least some embodiments, each of the first and second common visual characteristics comprises a respective shading element.

In at least some embodiments, the first and second subgroups comprise one or more of a geographic origin subgroup, an asset style subgroup, a market classification subgroup, and a market sector subgroup.

In at least some embodiments, the first asset class comprises fixed income assets, and wherein the second asset class comprises equity assets.

In at least some embodiments, the first and second groups are expandable to reveal a plurality of additional entries each displaying at least one of a respective additional identifier and a respective additional numerical value and disposed in at least one additional first and additional second subgroups, the at least one additional first and additional second subgroups associated with respective additional market characteristics distinct from the first and second market characteristics, the additional entries of the additional first and additional subgroups being disposed substantially contiguously and sharing respective additional first and additional second common visual characteristics associated with each additional first and additional second subgroups.

In at least some embodiments, the first and second entries are interactive, further comprising a filtering window configured for receiving input regarding a condition for a value of at least one of the first and second entries.

In at least some embodiments, the investment visualization tool further comprises an interactive slidable element disposed along a linear path between a first end and a second end, wherein the visual characteristics of each of the first and second entries are selectively alterable based on the position of the slidable element along the linear path.

In at least some embodiments, the investment visualization tool further comprises a third group representative of a listing of top holdings, the third group comprising a plurality of third entries each displaying a respective third identifier and a respective third numerical value, the third entries disposed substantially contiguously and spaced from the first and second groups, the third entries sharing a third common visual characteristic distinct from the first and second common visual characteristics.

In at least some embodiments, the investment visualization tool further comprises a third group representative of a listing of aggregate underlying holdings, the third group comprising a plurality of third entries each displaying a respective third identifier and a respective third numerical value, the third entries disposed substantially contiguously and spaced from the first and second groups, the third entries sharing a third common visual characteristic distinct from the first and second common visual characteristics.

In accordance with another broad aspect, there is provided a method for visualizing a financial instrument. An indication of the financial instrument is obtained. Information relating to the composition of the financial instrument is obtained. The information is subdivided into a plurality of groups associated with respective asset classes. The information of each group is subdivided into a plurality of subgroups associated with respective market characteristics. A plurality of entries is displayed, according to the groups and the subgroups. Each of the entries presents at least part of the information, and the entries of each subgroup share a respective common visual characteristic associated with their respective subgroup.

The method as defined herein may also include, in whole or in part, and in any combination, one or more of the following additional steps.

In at least some embodiments, subdividing the information into a plurality of groups comprises subdividing the information into at least a first asset class associated with fixed income assets and a second asset class associated with equity assets.

In at least some embodiments, at least some of the first subgroups and second subgroups are associated with common market characteristics.

In accordance with a further broad aspect, there is provided a method for searching for a financial instrument. An indication of a selected entry is obtained, the entry belonging to a group associated with an asset class and to a subgroup associated with a market characteristic. A condition for a value of the entry is obtained, the value related to the market characteristic. A list of a plurality of financial instruments is filtered to select at least one of the financial instruments which satisfies the condition. A filtered list, consisting of the at least one selected financial instruments, is displayed.

In accordance with another broad aspect, there is provided a system for visualizing a financial instrument. The system comprises a processing unit and a non-transitory computer-readable medium having stored thereon computer-readable instructions. The instructions are executable by the processing unit for: obtaining an indication of the financial instrument; obtaining information relating to the composition of the financial instrument; subdividing the information into a plurality of groups associated with respective asset classes; subdividing the information of each group into a plurality of subgroups associated with respective market characteristics; and displaying a plurality of entries according to the groups and the subgroups, each of the entries presenting at least part of the information, the entries of each subgroup sharing a respective common visual characteristic associated with their respective subgroup.

In accordance with a still further broad aspect, there is provided an investment visualization tool. The investment visualization tool comprises a group of a plurality of entries associated with an asset class. The group comprises at least two subgroups associated with respective market characteristics. The first group also comprises the plurality of first entries, each displaying a respective identifier and/or a respective numerical value, the entries each being disposed in one of the at least two subgroups, sharing a common visual characteristic associated with each subgroup, and disposed substantially contiguously within the subgroups.

Features of the systems, devices, and methods described herein may be used in various combinations, and may also be used for the system and computer-readable storage medium in various combinations. In particular, any of the above features may be used alone, together in any suitable combination, and/or in a variety of arrangements, as appropriate

### BRIEF DESCRIPTION OF THE DRAWINGS

Further features and advantages of embodiments described herein may become apparent from the following detailed description, taken in combination with the appended drawings, in which:

FIG. 1 illustrates an example of a financial instrument visualization tool.

FIGS. 2A-B illustrate an embodiment of a fixed income group of the tool of FIG. 1.

FIGS. 3A-B illustrate an embodiment of an equity group of the tool of FIG. 1.

FIGS. 4A-B illustrate an embodiment of an instrument allocation group of the tool of FIG. 1.

FIGS. 5A-B illustrate an embodiment of a supplementary group for the tool of FIG. 1.

FIG. 6 illustrates an embodiment of an instrument selection menu for the tool of FIG. 1.

FIG. 7 illustrates an embodiment of a search box for the tool of FIG. 1.

FIG. 8A-C illustrate an example of a financial instrument search tool.

FIG. 9 is a flowchart illustrating an example method for visualizing a financial instrument.

FIG. 10 is a flowchart illustrating an example method for searching for a financial instrument.

FIG. 11 is a schematic diagram of an example computing system for implementing the method of FIGS. 9 and/or 10 in accordance with an embodiment.

FIG. 12 is a block diagram of an example implementation of a system for visualizing a financial instrument.

It will be noted that throughout the appended drawings, like features are identified by like reference numerals.

### DETAILED DESCRIPTION

There is provided herein methods and systems for producing and operating financial tools relating to instrument visualization and instrument search. The financial tools disclosed herein can present investors with information relating to the composition of financial instruments of various types, including mutual funds, segregated funds, fund of funds, portfolio of funds/ETFs, and the like. Alternatively, or in addition, the financial tools disclosed herein can assist investors with searching for financial instruments having a selected composition. It should be noted that any numerical values presented in the present disclosure are for illustration purposes only, and may not be representatives of actual values.

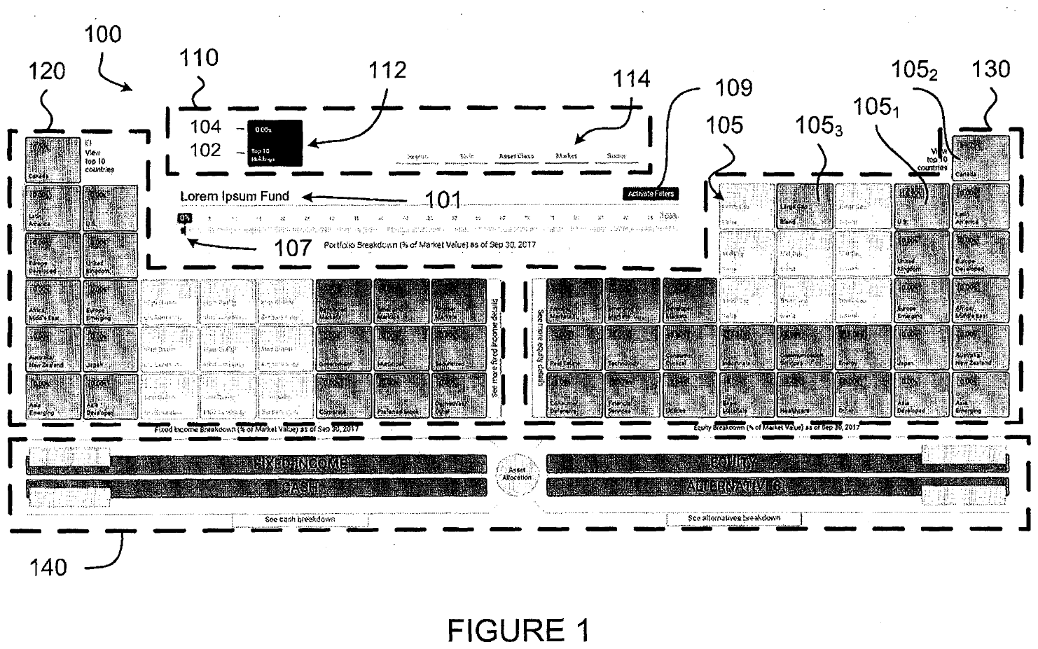

With reference to FIG. 1, a composition visualization tool (CVT) 100 is illustrated. The CVT 100 is a table-like graphical representation which provides a visualization of the composition of a financial instrument, for example a mutual fund, which can be named or otherwise indicated via a title shown at 101, in this case the Lorem Ipsum Fund. In some instances, the CVT 100 can be disposed so as to resemble the periodic table of the elements, although other configurations are also considered. The CVT 100 is composed of a plurality of entries 105 which are each disposed into one of a plurality of groups. In the embodiment of FIG. 1, the CVT 100 includes groups 120, 130, and 140, but other embodiments can include more, or fewer groups, as appropriate. Optionally, the CVT 100 can include a legend 110, which can be composed of an entry legend 112 and a market characteristic legend 114. The entry legend 112 provides indications for understanding the entries 105, and the market characteristic legend 114 provides indications for understanding the organization of the entries 105, as described in greater detail hereinbelow. In other embodiments, the legend 110 can include further information, as appropriate. For example, the legend entry 112 can be used to indicate information about the financial instrument 101, for instance a percentage (via numerical value 104) of the assets of the financial instrument 101 which are composed of the top-10 holdings within the financial instrument (as indicated via the identifier 102), described in greater detail hereinbelow. In other examples, the legend entry 112 can be used to identify a singular top holding, a proportion of the financial instrument represented by a top holding, a top-10 holdings, a top-25 holdings, or other suitable information.

In the embodiment of FIG. 1, groups 120, 130 each consist of entries 105 which are associated with a particular asset class. For example, the group 120 can be a fixed income group, and the group 130 can be an equity group. In this fashion, each of the entries 105 (graphically represented by individual boxes within the respective group) in the fixed income group 120 relate to fixed income components or constituent parts contained within the selected financial instrument 101, and each of the entries 105 in the equity group 130 relate to equity components or constituent parts contained in the selected financial instrument 101. In other embodiments, additional groups relating to other asset classes, for instance cash, alternatives, or the like, are also considered. The fixed income group 120 and the equity group 130 are spaced laterally from one another in the table, for example to illustrate the distinct nature of the entries 105 in each group. In addition, the embodiment the CVT 100 in FIG. 1 includes the asset class group 140, which is composed of entries 105 which show the asset allocation and thus which relate to different asset classes, in this case fixed income, equity, cash, and alternatives.

Each of the entries 105 represents a different characteristic of the financial instrument 101, and provides information regarding at least said characteristic. Using as an example the entry legend 112, each entry 105 includes the identifier 102, and can optionally include the numerical value 104. The identifier 102 can be any suitable qualitative indication of a characteristic of the financial instrument 101. As will be described in greater detail hereinbelow, the identifier 102 can relate to a geographic origin, an asset style, a market classification, a market sector, an asset class, or any other suitable characteristic of the financial instrument 101. The numerical value 104, where appropriate, can indicate a relative ponderation of the characteristic in the assets which compose the financial instrument 101.

For instance, the entry 105₁ in the equity group 130 relates to a geographical origin of some of the assets which compose the financial instrument 101. The entry 105₁ includes an identifier 102, which reads “U.S.”, and a numerical value, which reads “16.90%”: this means that 16.90% of the equity-class assets in the financial instrument 101 originate in the United States of America. The entry 105₂ includes an identifier 102, which reads “Canada”, and a numerical value, which reads “59.79%”: this means that 59.79% of the equity-class assets in the financial 101 originate in Canada. It should be noted that in other embodiments, the numerical value 104 can indicate the proportion of each entry as a function of the entirety of the financial instrument 101. That is to say, taking the example of entry 105₁, the numerical value which reads “16.90%” can indicate that 16.90% of all assets in the financial instrument 101 originate in the United States of America. Optionally, the CVT 100 may be configurable, for instance by a user of the CVT 100, to present numerical values 104 on the basis of the financial instrument 101 as a whole, on a per-asset-class basis, or as a proportion of any other suitable reference.

Other entries 105 in the CVT 100 can provide information regarding other characteristics of the financial instrument 101, including regarding the geographical origin of the remaining portion of the assets in the financial instrument 101, or regarding other characteristics. For instance, the entry 105₃ in the equity group 130 relates to an asset style for the equity assets within the financial instrument 101. In this case, the entry 105₃ has an identifier 102 which reads “Large Cap Blend”, indicating that the equity assets in the financial instrument 101 are a “blend” of both value and growth assets which have large capitalization, as opposed to mid-sized or small capitalization. Since the “Large Cap Blend” asset style characterization is relevant to the financial instrument 101 as a whole, only one entry 105 within this portion of the equity group 130 is highlighted. Other definitions and guidelines for classifying the style of assets are considered.

The entries 105 in the asset class group 140 also include an identifier 102, in this case terms relating to the asset class represented by each entry 105, and a numerical value 104 which indicates the ponderation of each asset class in the financial instrument 101. In this fashion, the entries 105 in the asset class group 140 provide an indication to a user of the CVT 100 of the breakdown of assets within the financial instrument 101 on the basis of different classes of assets. It should be noted that in other embodiments, the asset class group 140 can include more, or fewer, entries 105, as appropriate.

The entries 105 can be disposed in a grid-like form, as illustrated in FIG. 1, and can all be of roughly the same shape and size. For example, the entries 105 present in groups 120 and 130 are all substantially of the same shape and size. In other cases, certain ones of the entries 105 can be of different shapes and sizes, for example the entries 105 of group 140, which are of a different shape and size than the entries 105 of groups 120 and 130. In some embodiments, each of the entries 105 of a particular group, for example the group 120 or 130, are of a common shape and size. In other embodiments, a given group can have entries 105 of varying shapes and sizes, as appropriate.

Once the breakdown of the financial instrument 101 is presented via the entries 105, a slidable element 107 can be used to set a presentation threshold for the entries 105. The slidable element 107 is disposed along a linear path, with one end associated with a low value, for instance 0%, and with the other end associated with a high value, for instance 100%. The presentation threshold is a value set inclusively between the low and high values at the ends of the linear path, and sets a threshold for the numerical values 104 of the entries 105: if a particular entry 105 has a numerical value 104 below the presentation threshold, the entry 105 can be faded, hidden from view, or otherwise have its visual characteristic altered based on the position of the slidable element 107. Entries 105 which have a numerical value 104 above the presentation threshold are not hidden, can be highlighted or otherwise made more prominent within the CVT 100. In some embodiments, a pair of sliding elements can be provided to establish a presentation range. Other approaches are also considered.

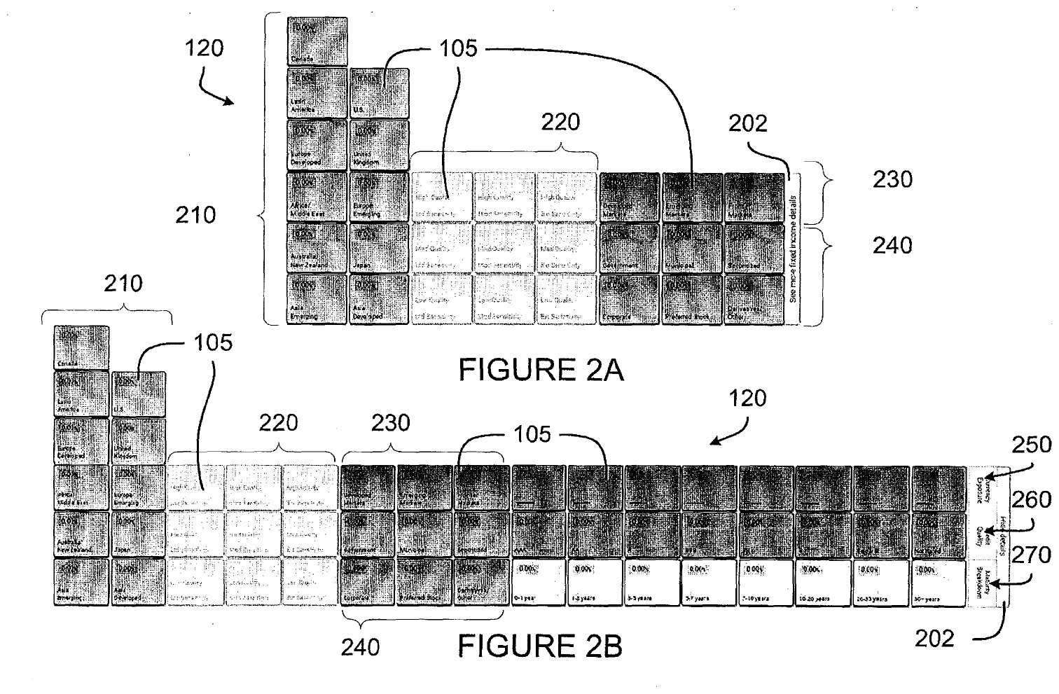

With additional reference to FIG. 2A, the entries 105 in the fixed income group 120 are substantially contiguously grouped into one of a variety of different subgroups, each associated with a particular market characteristic, such that the entries 105 in each subgroup provide information regarding a single market characteristic. In the example of FIG. 2A, the subgroups include a geographic origin subgroup 210, which groups entries 105 pertaining to the geographic origin of assets within the financial instrument 101, an asset style subgroup 220, which groups entries 105 pertaining to the class of assets within the financial instrument 101, a market classification subgroup 230, which groups entries 105 pertaining to the market classification of assets within the financial instrument 101, and a market sector subgroup 240, which groups entries 105 pertaining to the market sector of assets within the financial instrument 101.

As part of the CVT 100, entries 105 are additionally each provided with a visual characteristic. The visual characteristic can be a colour, a shading, a pattern, or any other visual information. In some embodiments, the visual characteristic for the entries 105 is specific to the subgroup in which the entries are disposed. In the example of FIG. 2A, the entries 105 are provided with different colours or shading based on the subgroup in which they are disposed: for example, the entries 105 of group 210 can be presented with a first shading, the entries 105 of group 220 in a second, different shading, and the entries 105 of groups 230 and 240 can also be presented with respective different shadings. In other embodiments, different colours can be used for each of the subgroups 210-240.

With continued reference to FIG. 1, the physical separation of the entries 105 into the fixed asset group 120 and the equity group 130 provides a visual indication to the user of the CVT 100 that the entries of each respective group present information relating to distinct asset classes. In addition, entries 105 in the asset class group 140 which provide information regarding fixed income and equity can be disposed proximate their respective groups. In this fashion, the user of the CVT 100 can recognize that group 120 relates to fixed income components of the financial instrument 100, and that group 130 relates to equity components of the financial instrument 100. Moreover, the visual characteristic assigned to each of the entries 105, in conjunction with the market characteristic legend 114, can help the user 100 quickly identify which of the entries 105 belong to which subgroup. The fixed income group 120 and the equity group 130 can include any number of subgroups, and in some cases, can include subgroups which relate to common market characteristics, and be presented with common visual characteristics across common subgroups.

With continued reference to FIG. 2A, and additional reference to FIG. 2B, in some embodiments the fixed income group 120 includes a button 202 with which a user of the CVT 100 can interact. When an interaction with the button 202 occurs, the fixed income group 120 can expand, as shown in FIG. 2B, to reveal one or more additional entries 105. The additional entries 105 can be disposed in one or more additional subgroups; in the example of FIG. 2B, the additional subgroups include a currency exposure subgroup 250, a credit quality subgroup 260, and a maturity breakdown subgroup 270, each with their own respective visual characteristic, which differs from that of the other subgroups in the fixed income group 120. The button 202 can receive subsequent interaction to then collapse the fixed income group 120, hiding the additional entries 105 of the groups 250-270.

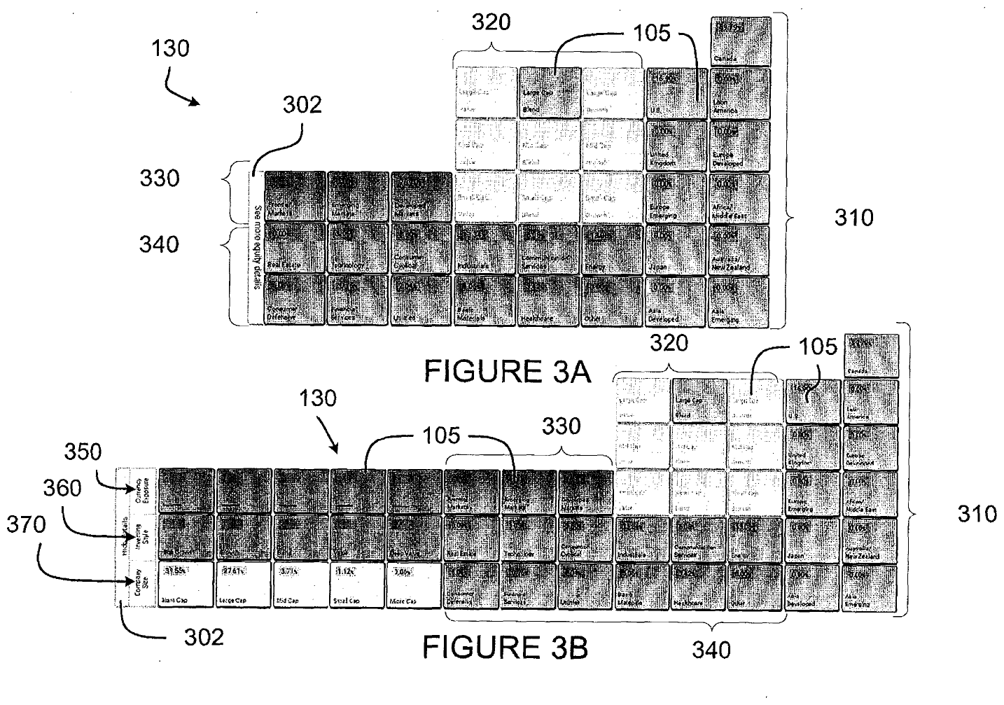

With reference to FIGS. 3A-B, the equity group 130 can be disposed substantially similarly to the fixed income group 120, that is to say, with a plurality of subgroups 310-340, each with respective visual characteristics. In some cases, at least some of the subgroups 310-340 relate to the same market characteristics as the subgroups 210-240. In the example illustrated in FIGS. 3A-B, the subgroups include a geographic origin subgroup 310, which groups entries 105 pertaining to the geographic origin of assets within the financial instrument 101, an asset style subgroup 320, which groups entries 105 pertaining to the class of assets within the financial instrument 101, a market classification subgroup 330, which groups entries 105 pertaining to the market classification of assets within the financial instrument 101, and a market sector subgroup 340, which groups entries 105 pertaining to the market sector of assets within the financial instrument 101. Thus, in the example illustrated in FIG. 3A-B, each of the subgroups 310-340 is analogous to a respective one of the subgroups 210-240 of the fixed income group 120. It should be noted that in other embodiments, the subgroups present in the groups 120, 130 may differ, or share any number of analogous subgroups, as appropriate.

Additionally, the equity group 130 includes a button 302 with which a user of the CVT 100 can interact. When an interaction with the button 302 occurs, the equity group 130 can expand, as shown in FIG. 3B, to reveal one or more additional entries 105. The additional entries 105 can be disposed in one or more additional subgroup, may or may not mirror the additional subgroups revealed via interaction with button 202 of the fixed income group 120. In the example of FIG. 3B, the additional subgroups include a currency exposure subgroup 350, an investing style subgroup 360, and a company size subgroup 370, each with their own respective visual characteristic, which differs from that of the other subgroups in the equity group 130. The button 302 can receive subsequent interaction to then collapse the equity group 130, hiding the additional entries 105 of the groups 350-370.

In some embodiments, the visual characteristics used for each of the additional subgroups 350-370 of the equity group 130 are common with visual characteristics used for the additional subgroups 250-270 of the fixed income group 120, even if they do not relate to common market characteristics. For example, if the CVT 100 is configured to display the additional subgroups 350-370 of the equity group 130 by completely collapsing and/or hiding the fixed income group 120, or by preventing both the fixed income group 120 and the equity group 130 to be expanded at the same time, common visual characteristics can be used across the different additional subgroups 250-270 and 350-370 without causing confusion for the user of the CVT 100. Alternatively, different visual characteristics can be used across the different additional subgroups 250-270 and 350-370. In some embodiments, the visual characteristics used across the different additional subgroups 250-270 and 350-370 may be similar but distinguishable from one another: for example, a common background colour can be used for some of the subgroups 250-270 and 350-370, but different patterning, shadows, or similar, can also be used, to facilitate visual differentiation by the user of the CVT 100.

In some embodiments, a subgroup may provide information via multiple ones of the entries 105 which compose the subgroup. For example, the geographic origin subgroup 210 of the fixed income group 120 can include multiple entries with numerical values 104, for instance in cases where the fixed income assets in the financial instrument 101 are from a variety of different geographical origins. In other embodiments, a subgroup may provide information via one or more selected ones of the entries 105 in the subgroup. For example, the asset style subgroup 320 can indicate a predominant asset style for the equity group 130 by highlighting a single one of the entries 105 and/or by fading or making transparent the remaining entries 105 in the asset style subgroup 320. If the financial instrument 101 includes a plurality of equity assets which belong to different asset styles, more than one of the entries 105 in the asset style subgroup 320 can be highlighted, for example. Other approaches for conveying information via the entries 105 are also considered.

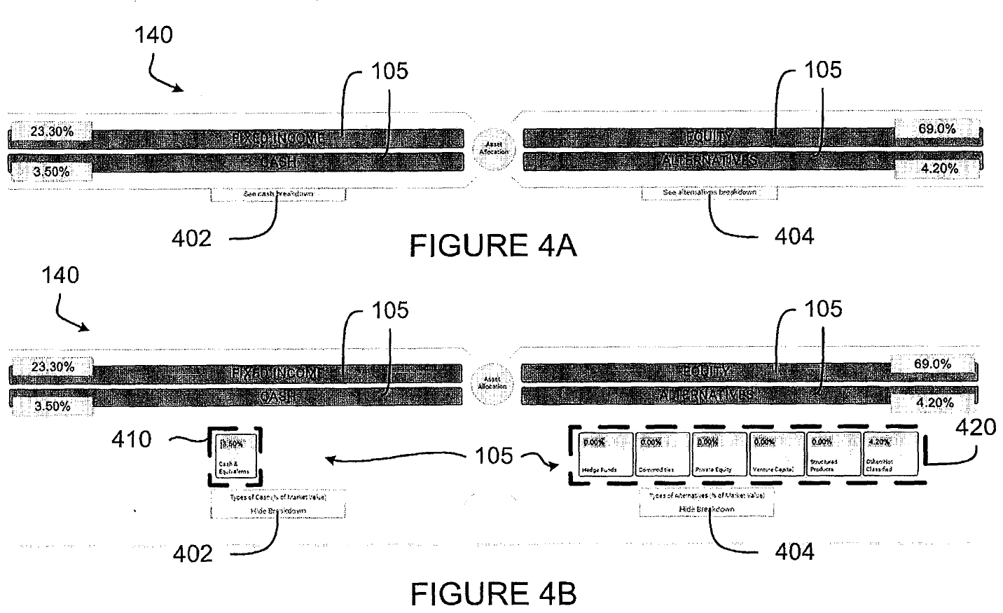

With reference to FIGS. 4A-B, as discussed hereinabove, the asset class group 140 is composed of entries 105 which provide information relating to the breakdown, by asset class, of the assets composing the financial instrument 101. In the example shown in FIGS. 4A-B, the financial instrument 101 is composed of 23.3% fixed income, 69.0% equity, 3.50% cash, and 4.20% alternative assets. The entries 105 relating to fixed income and equity can be disposed proximate the fixed income group 120 and equity group 130, respectively, as illustrated in FIG. 1, thereby indicating to the user of the CVT 100 that further information regarding the fixed income and equity assets in the financial instrument 101 are provided in the groups 120, 130.

In some embodiments, the asset class group 140 can be provided with interactive buttons 402, 404, which can be respectively associated with the cash and alternatives entries 105. By interacting with button 402, cash group 410, which includes one or more additional entries 105 relating to the cash assets composing the financial instrument 101, can be displayed. For example, an entry 105 relating to cash and equivalents, as illustrated in FIG. 4B, can be displayed. Similarly, interacting with button 404 can cause alternatives group 420, which includes one or more additional entries 105 relating to the alternative assets composing the financial instrument 101, to be displayed. For example, entries relating to hedge funds, commodities, private equity, venture capital, structured products, and/or other or unclassified assets can be displayed. It should be understood that the additional entries 105 for both the cash assets and the alternative assets can include any other suitable entries 105 providing information relating to the breakdown of the assets composing the financial instrument 101, relative to those asset classes.

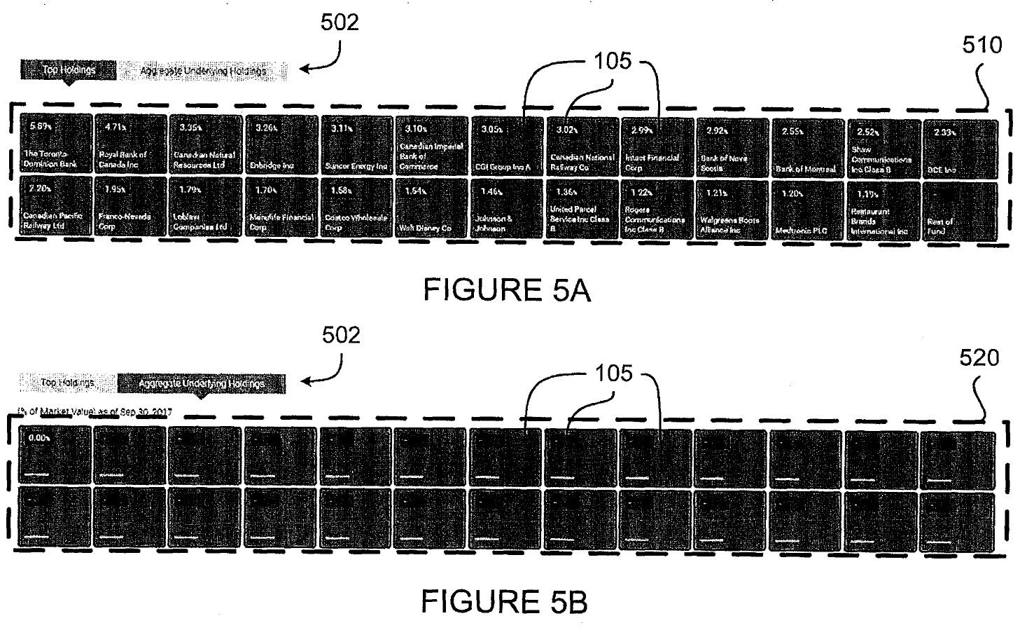

With reference to FIGS. 5A-B, in some embodiments, one or more additional groups can be displayed as part of the CVT 100, for example a top holdings group 510, with entries indicating financial assets which compose the largest proportion of the financial instrument 101 across all asset classes, an aggregate underlying holdings group 520, with entries indicating a breakdown of the assets of the financial instrument 101 by aggregate underlying holdings across all asset classes, or any other suitable other groups. The additional groups 510, 520 can include any suitable number of entries, and can be displayed with visual characteristic(s) different from those of any of the subgroups 210-270 and 310-370. For example, the top-holdings group 510 can include 26 entries, of which the first 25 list the top-25 holdings within the financial instrument 101 and indicate the proportion of each of the top 25-holdings as a function of the financial instrument 101, and the 26^{th} entry indicates the proportion of the remainder of assets of the financial instrument 101. The aggregate underlying holdings group 520 can be similarly implemented, and other examples are also considered. The additional groups 510, 520 can be disposed in any suitable arrangement relative to the groups 120, 130, 140, for example below the groups 120, 130, 140. In some embodiments, the entries 105 in all additional groups 510, 520 can be presented with a common visual characteristic. In some embodiments, buttons 502 can be interact with to cycle between the one or more additional groups 510, 520. In some embodiments, the CVT 100 can be provided with a toggle or other interactive element to cause the additional groups 510, 520 to be presented. In other embodiments, the additional groups 510, 520 can be presented by navigating the CVT 100 to a different portion thereof, for example by scrolling down a page. Other embodiments are also considered.

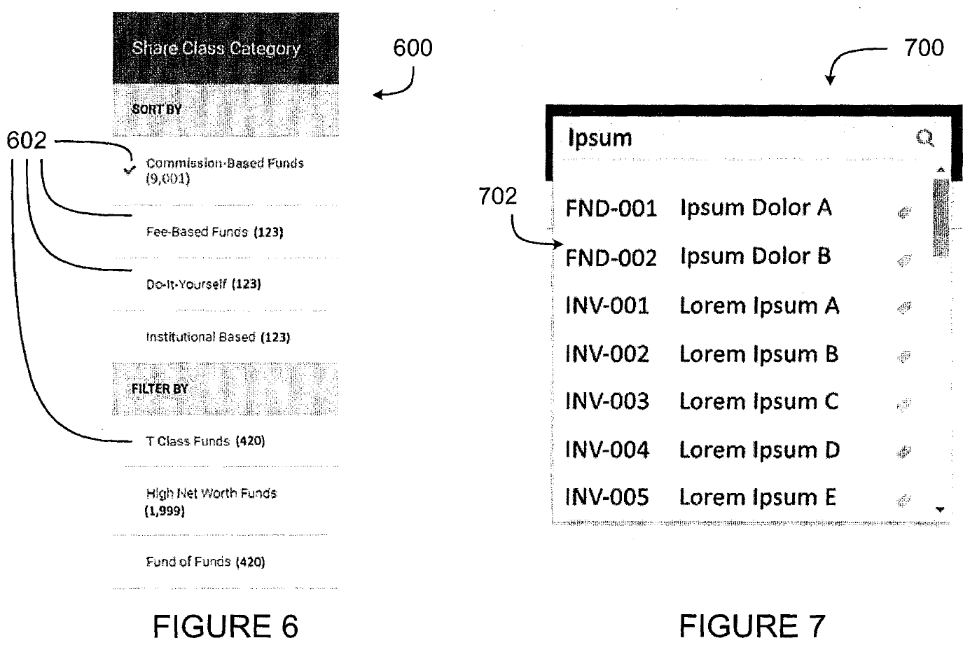

With reference to FIG. 6, in some embodiments the CVT 100 can include a share class category menu 600, which can be accessible via an interactive element within the CVT 100, and can be disposed relative to the other elements of the CVT in any suitable arrangement. The share class category 600 can permit the user of the CVT 100 to select a category of financial instruments which can be accessed and visualized via the CVT 100, each of which can be associated with a respective menu entry 602. For example, in some jurisdictions, financial instruments may be classified into one of a plurality of categories based on various regulatory provisions. The CVT 100 can respond to the selection of one of the menu entries 602 by the user and, for example, update the groups 120, 130, 140, and/or any one or more of the subgroups 210-270 and 310-370, based on the nature of the financial instruments in each of the categories. The share class category menu 600 can also allow the user to select a category when searching for financial instruments, as described hereinbelow.

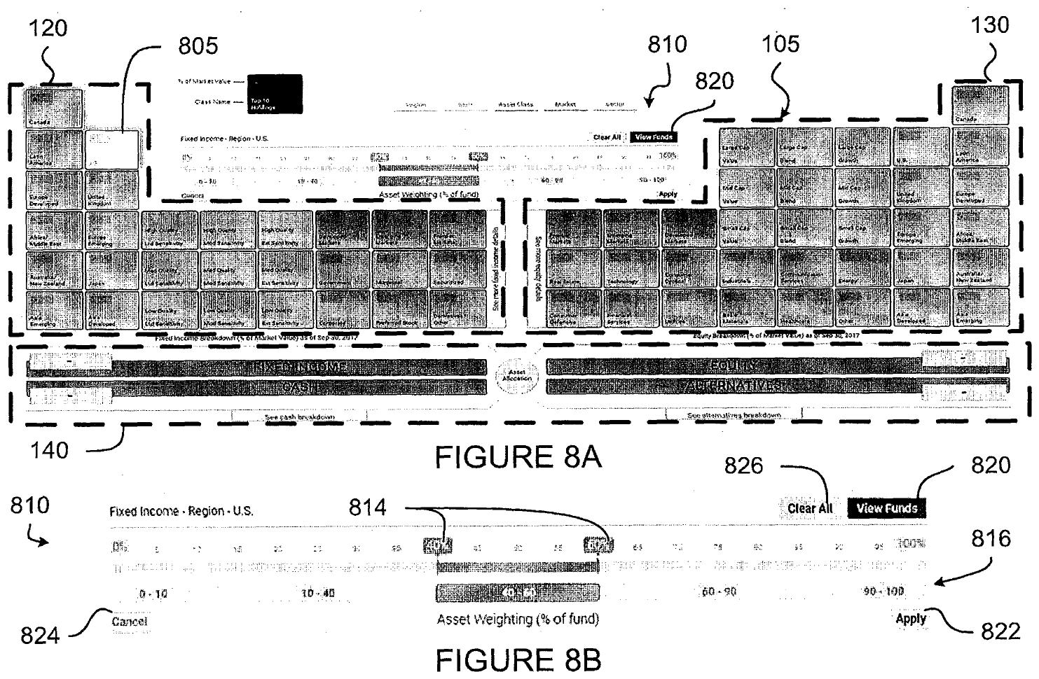

With reference to FIG. 7, the CVT 100 can include a search box 700, via which the user of the CVT 100 can search for financial instruments based on one or more characteristics. The search box 700 can be disposed at any suitable location relative to the other elements of the CVT 100, for example above the groups 120, 130, 140, proximate the legend 110, or at any other suitable location. The search box 700 can permit searching for financial instruments based on name, reference number, originating financial institution, or any other suitable characteristic. When searching, the search box 700 can produce one or more search results 702, each indicative of a different financial instrument, and which can be interactive. By selecting one of the search results 702, the CVT 100 can be updated to visualize the selected financial instrument, including populating the identifiers 102 and, where appropriate, the numerical values 104, of each of the entries 105. In some instances, the particular layout of the groups 120-140, the arrangement and visual characteristics of the subgroups 210-270 and 310-370, the number and nature of the entries 105 in the CVT 100, and any other suitable characteristic of the CVT 100 can be updated to properly visualize the assets composing the selected financial instrument.

With continuing reference to FIG. 1, the CVT 100 can also include an interactive button 109. The interactive button 109 can be disposed at any suitable location within the CVT 100, for instance proximate the slidable element 107. The interactive button 109 can be used to initiate a filtering operation. The filtering operation can include a filter search, which can facilitate the identification of financial instruments having certain characteristics, as identified by a user of the CVT 100.

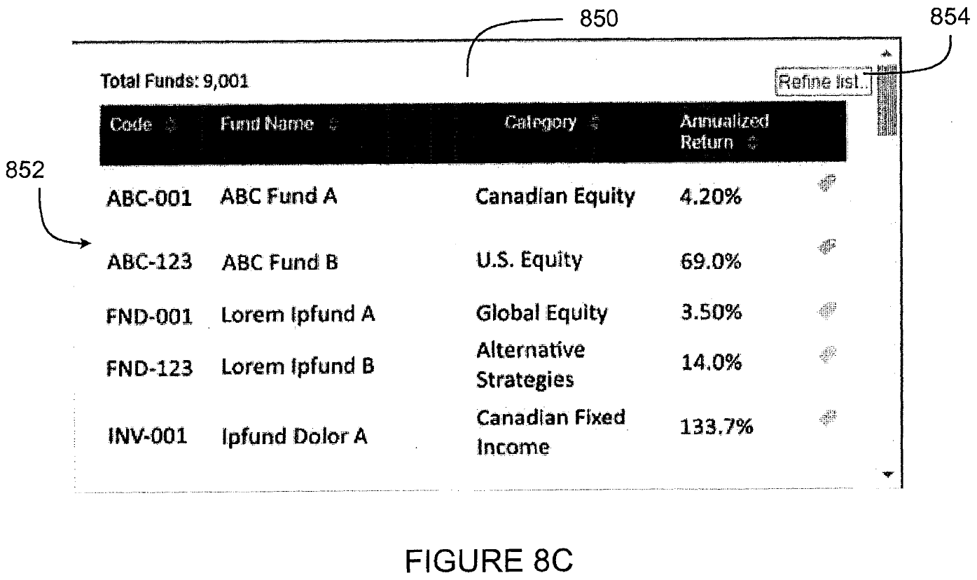

With additional reference to FIGS. 8A-C, following an interaction with the interactive button 109, the CVT 100 enters a filter search mode in which, based on conditions assigned to one or more of the entries 105, a search can be performed to identify financial instruments matching the conditions. When the filter search mode is activated, the interactive button 109 is replaced with an interactive button 820, a filtering window 810 is caused to become active, and the entries 105 of the groups 120-140 are caused to become active for filtering. When active for filtering, the entries 105 become selectable by the user of the CVT 100. For example, as illustrated in FIG. 8A, entry 805, located in the geographic origin subgroup 210 of the fixed income group 120, has become active following a selection by the user. In some cases, the active nature of the entry 805 is shown by modifying the visual characteristic of the entry 805, for example to be different from the other entries in the subgroup to which the entry belongs (in this case the geographic origin subgroup 210), and optionally to be different from all other entries 105 within the CVT 100. For instance, the entry 805 can be highlighted, shaded, or otherwise presented in a visually differentiable way from the remaining entries 105 of the CVT 100. In some embodiments, the entry 112 of the legend 110 is also selectable for filtering, as described hereinbelow, for instance to establish a condition associated with the ponderation of top-10 holdings within a financial instrument.

Once the entry 805 is selected, the filtering window 810 is configured for presenting a plurality of interactive elements to allow the user of the CVT 100 to specify one or more conditions for the entry 805, for instance relating to the numerical value for the entry 805. Put differently, via the filtering window 810, the user of the CVT 100 can specify conditions indicative of a desired composition of financial instruments. Once the user has specified one or more conditions, a search can be performed for financial instruments meeting all of the conditions, which can then be displayed via a results window 850, illustrated in FIG. 8C.

With continued reference to FIG. 8B, sliding elements 814 can be used to select an allowable range for the numerical value of the entry 805. Alternatively, or in addition, selectable elements 816 can be used to assign one of a variety of different predetermined ranges for the numerical value of the entry 805. Other approaches for providing the allowable range for the numerical value are considered, for example text boxes, drop-down menus, and the like. For entries 105 which do not have a numerical entry, for instance the entries 105 in subgroups 220 and 320, interacting with the entries 105 may be sufficient for assigning a condition associated with the particular entry. For instance, the user can select the “Large Cap Blend” entry in group 320 to set as a condition that all financial instruments displayed in results window 850 consist of large cap blended assets. In another instance, a subgroup as a whole can be selected by interacting with any of the entries of the subgroup, and the filtering window 810 can present one or more drop-down menus, or other interactive elements, as appropriate, via which the user can specify one or more conditions for the selected subgroup. Other approaches are also considered. For instance, a user could enter a particular security or stock in a text box, and then specify an allowable range or value for the particular security or stock, for instance via the selectable elements 816. Alternatively, or in addition, the user could indicate that one or more stocks or securities should form part of the top-10 or top-25 holdings of financial instruments displayed in search results. Particular stocks or securities can be indicated by name, by number, or using any other suitable identifier.

If the user is satisfied with the selected range, the range can be applied to the entry 805 by interacting with the apply button 822; to cancel the selected range, the user can interact with cancel button 824. The user can provide any suitable number of conditions, associated with respective entries 105. If the user wishes to clear all conditions set for the entries 105, the user can interact with clear all button 826. Once the user has set all desired conditions, the user can interact with view funds button 820 to cause the results window 850 to appear.

The results window 850 can present any suitable number of results 852, based on those financial instruments which satisfy the conditions established by the user via the CVT 100. The results 852 can be interactive, or contain an interactive element, via which the CVT 100 can visualize the composition of a selected one of the results 852. This can include populating the identifiers 102 and, where appropriate, the numerical values 104, of each of the entries 105. In some instances, the particular layout of the groups 120-140, the arrangement and visual characteristics of the subgroups 210-270 and 310-370, the number and nature of the entries 105 in the CVT 100, and any other suitable characteristic of the CVT 100 can be updated to properly visualize the assets composing the financial instrument selected from the results window 850.

In some embodiments, the results 852 for a particular set of conditions can be saved, for example within a profile of the user. In some embodiments, the CVT 100 can be made to cycle through the results 852 for a particular set of conditions, for instance via arrow keys, or other interactive elements of the CVT 100. The results window 850 can further include a refining search box 854, via which the user of the CVT 100 can search for financial instruments within the results 852 based on one or more characteristics, for example based on name, reference number, originating financial institution, or any other suitable characteristic. In some embodiments, the results 852 can be updated substantially in real-time in response to entry of information into the refining search box 854.

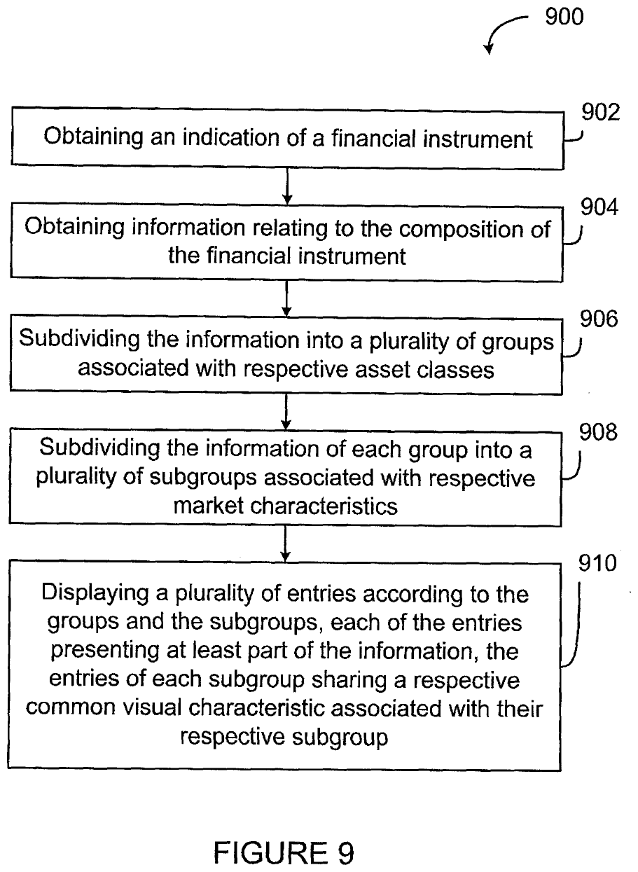

With reference to FIG. 9, there is shown a flowchart illustrating a method 900 for visualizing a financial instrument, for example the financial instrument 101. At step 902, an indication of the financial instrument 101 is obtained. The indication can be provided by a user interacting with a result 702 of the search box 700, a result of the results window 850, or in any other suitable fashion. The indication can include a name, a reference number, or any other information suitable for identifying the financial instrument 101.

At step 904, information relating to the composition of the financial instrument 101 is obtained. The composition information is indicative of the asset(s) which compose the financial instrument 101, and can be obtained from any suitable source, including financial regulators, financial institutions, information brokers, and the like.

At step 906, the information is subdivided into a plurality of groups, each of the groups being associated with respective asset classes. The groups can include the fixed income group 120, the equity group 130, or any other suitable groups, such as cash, alternatives, and the like. At step 908, the information of each group is further subdivided into a plurality of subgroups, each associated with respective market characteristics. The subgroups can include any one or more of the subgroups 210-270 and/or 310-370 described hereinabove, or any other suitable subgroups. The subdivision of the information can be performed using any suitable sorting algorithms, calculations, and the like.

At step 910, a plurality of entries, for example the entries 105, are displayed. The entries 105 are arranged according to the groups and subgroups, with each of the entries 105 presenting at least a part of the information and with each of the entries of each subgroup sharing a respective common visual characteristic associated with their respective subgroup. The visual characteristic can be a colour, a shading, a pattern, or any other visual information.

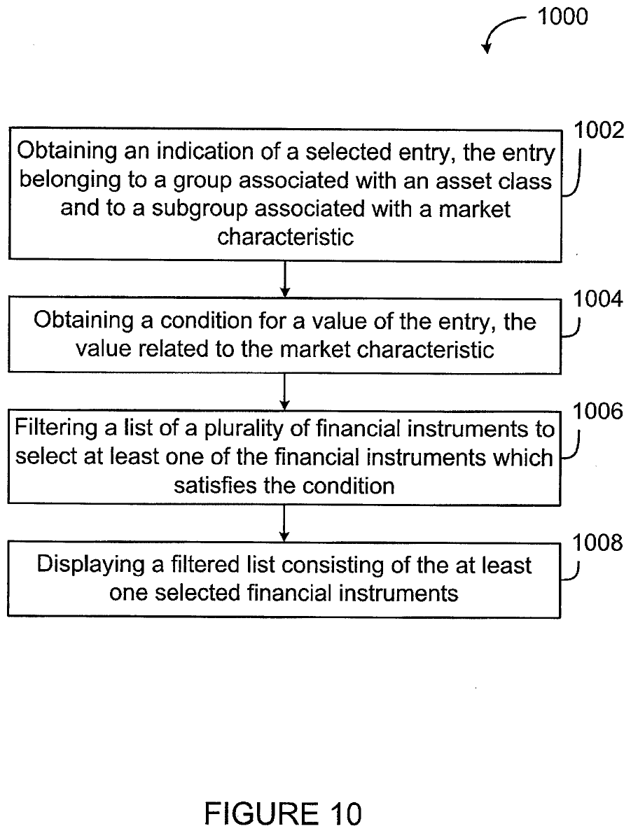

With reference to FIG. 10, there is shown a flowchart illustrating a method 1000 for searching for a financial instrument. At step 1002, an indication of a selected entry is obtained, the entry belonging to a group associated with an asset class and to a subgroup of the group, which is associated with a market characteristic. The entry can be, for example, any one of the entries 105 displayed as part of the CVT 100.

At step 1004, a condition for a value of the entry is obtained, in which the value is related to the market characteristic. The value can be a quantitative value, for example a range of numerical values, or a qualitative value. An example quantitative value can be a range of 10% to 40% for a market characteristic of geographical origin from the United States of America. An example qualitative value can be a selection of large capitalization from a list of small, mid-sized, and large. Other example are considered.

At step 1006, a list of a plurality of financial instruments is filtered to select at least one of the financial instruments which satisfies the condition. Any suitable sorting or filtering algorithms can be used. It should be noted that in some embodiments, a plurality of conditions can be set, for example by repeating steps 1002 and 1004 until receipt of a search command or similar indication.

At step 1008, a filtered list, consisting of the at least one selected financial instruments, is displayed. In some embodiments, the filtered list is presented in a manner resembling the results window 850. Other embodiments are considered.

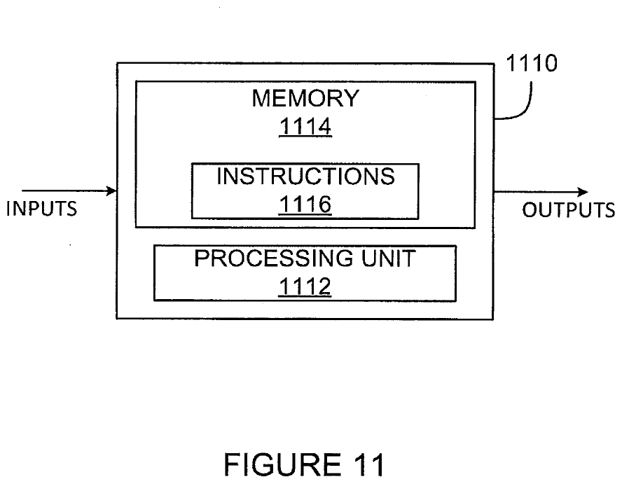

With reference to FIG. 11, the methods 900 and/or 1000 may be implemented by a computing device 1110, comprising a processing unit 1112 and a memory 1114 which has stored therein computer-executable instructions 1116. The processing unit 1112 may comprise any suitable devices configured to cause a series of steps to be performed so as to implement the methods 900 and/or 1000 such that instructions 1116, when executed by the computing device 1110 or other programmable apparatus, may cause the functions/acts/steps specified in the methods 900 and/or 1000 described herein to be executed. The processing unit 1112 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory 1114 may comprise any suitable known or other machine-readable storage medium. The memory 1114 may comprise non-transitory computer readable storage medium, for example, but not limited to, an electronic, magnetic, optical, electromagnetic, infrared, or semiconductor system, apparatus, or device, or any suitable combination of the foregoing. The memory 1114 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 1114 may comprise any storage means (e.g., devices) suitable for retrievably storing machine-readable instructions 1116 executable by processing unit 1112.

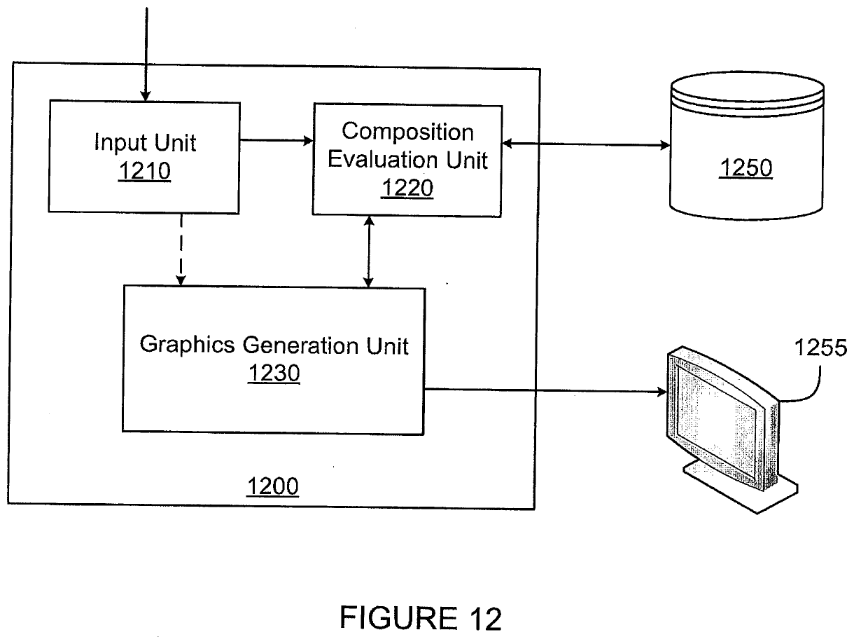

With reference to FIG. 12, a system 1200 for generating the CVT 100 is shown. The system 1200 comprises an input unit 1210, a composition evaluation unit 1220, and a graphics unit 1230, and is configured for receiving user input and optionally for communicating with a financial information database 1250. Additionally, the system 1200 is configured for providing output to a display device 1255, which can be any suitable display device, such as a screen, a projector, and the like.

The input unit 1210 is configured for receiving user input, including an indication of a financial instrument, in accordance with step 902, and/or an indication of a selected entry and a condition for a value of the entry, in accordance with steps 1002 and 1004. The input unit can receive the selection via any suitable input device, as discussed hereinabove. Alternatively, or in addition, the input unit can receive the selection via one or more networks, one or more wired or wireless connections, or via any other suitable path. The input unit 1210 is configured for sending the indication to the composition evaluation unit 1220.

The composition evaluation unit 1220 is configured for receiving from the input unit 1210 the indication of the financial instrument and/or of the selected entry and the corresponding condition. In some embodiments, the input unit 1210 can provide the composition evaluation unit 1220 with a plurality of selected entries and respective corresponding conditions. The composition evaluation unit 1220 can then acquire information from the financial information database 1255, or from any other suitable source which can be internal or external to the system 1200. When implementing the method 900, the composition evaluation unit 1220 can subdivide the information into groups, associated with asset classes, and subgroups, associated with market characteristics, as per steps 906 and 908. When implementing the method 1000, the composition evaluation unit 1220 is configured for filtering a list of financial instruments, for example obtained from the financial information database 1255, to select at least one financial instrument which satisfied the condition(s) obtained from the input unit 1210, as per step 1006. The composition evaluation unit 1220 can produce, for example, a filtered list with the selected financial instruments.

The graphics unit 1230 is configured for receiving the groups and subgroups from the composition evaluation unit 1220, and the associated information, to display a plurality of entries, for example the entries 105, according to the groups and subgroups, as per step 910, for example as the CVT 100. The entries 105 each include some of the information, for instance the identifiers 102 and the numerical values 104. The entries 105 of each subgroup also share a common visual characteristic associated with their subgroup. The graphics unit 1230 is also configured for receiving the filtered list from the composition evaluation unit 1220, and for displaying the filtered list, consisting of the selected financial instruments, as per step 1008, for example as results window 850.

The graphics unit 1230 can use any suitable graphics suite or software to display the CVT 100 and/or the results window 850. In some embodiments, the graphics unit 1230 is configured for displaying the CVT 100 and/or the results window 850 on the display device 1255 via any suitable display protocol, including HDMI (High-Definition Multimedia Interface), DisplayPort, and the like, or any suitable wireless display protocol. In other embodiments, the graphics unit 1230 is configured for displaying the CVT 100 and/or the results window 850 on a screen via a projector. In certain embodiments, the graphics unit 1230 is configured for storing the CVT 100 and/or the results window 850, or information relating thereto, in an internal or external database.

Other functionality can be imparted to any one or more of the input unit 1210, the composition evaluation unit 1220, and the graphics unit 1230, as appropriate.

The methods and systems for visualizing a financial instrument described herein may be implemented in a high level procedural or object oriented programming or scripting language, or a combination thereof, to communicate with or assist in the operation of a computer system, for example the computing device 1110. Alternatively, the methods and systems described herein may be implemented in assembly or machine language. The language may be a compiled or interpreted language. Program code for implementing the methods and systems described herein may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems described herein may also be considered to be implemented by way of a non-transitory computer-readable storage medium having a computer program stored thereon. The computer program may comprise computer-readable instructions which cause a computer, or more specifically the processing unit 1112 of the computing device 1110, to operate in a specific and predefined manner to perform the functions described herein.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure.

Various aspects of the method and system disclosed herein may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments. Although particular embodiments have been shown and described, it will be obvious to those skilled in the art that changes and modifications may be made without departing from this invention in its broader aspects. The scope of the following claims should not be limited by the preferred embodiments set forth in the examples, but should be given the broadest reasonable interpretation consistent with the description as a whole.

1. An investment visualization tool, comprising:
a first group associated with a first asset class, the first group comprising:
at least two first subgroups associated with respective first market characteristics; and
a plurality of first entries graphically represented within the first group and each sharing a respective first common visual characteristic based on an associated one of the at least two first subgroups and being disposed substantially contiguously therein, wherein each of the plurality of entries displays a respective first identifier and/or a respective first numerical value;
a second group associated with a second asset class, the second group laterally spaced from the first group and comprising:
at least two second subgroups associated with respective second market characteristics; and
a plurality of second entries graphically represented within the second group and each sharing a respective second common visual characteristic based on an associated one of the at least two second subgroups and being disposed substantially contiguously therein, wherein each of the plurality of entries displays a respective second identifier and/or a respective second numerical value.

2. The investment visualization tool of claim 1, further comprising a third group representative of a plurality of asset classes comprising the first and second asset classes, the third group comprising a plurality of third entries each displaying a respective third identifier and a respective third numerical value, the third entries disposed substantially contiguously and spaced from the first and second groups, the third entries sharing a third common visual characteristic distinct from the first and second common visual characteristics.

3. The investment visualization tool of claim 2, wherein the plurality of asset classes comprises fixed income assets, equity assets, cash assets, and alternative assets.

4. The investment visualization tool of claim 2, wherein at least some of the third entries are expandable to reveal a plurality of additional entries each displaying at least one of a respective additional identifier and a respective additional numerical value and associated with a respective additional market characteristic distinct from the first and second market characteristics.

5. The investment visualization tool of claim 1, wherein at least some of the first subgroups and second subgroups are associated with common market characteristics, and wherein the respective first common visual characteristics of the at least two first subgroups correspond to the respective second common visual characteristics of the at least two second subgroups.

6. The investment visualization tool of claim 1, wherein each of the first and second common visual characteristics comprises a respective colour element.

7. The investment visualization tool of claim 1, wherein each of the first and second common visual characteristics comprises a respective shading element.

8. The investment visualization tool of claim 1, wherein the first and second subgroups comprise one or more of a geographic origin subgroup, an asset style subgroup, a market classification subgroup, and a market sector subgroup.

9. The investment visualization tool of claim 1, wherein the first asset class comprises fixed income assets, and wherein the second asset class comprises equity assets.

10. The investment visualization tool of claim 1, wherein the first and second groups are expandable to reveal a plurality of additional entries each displaying at least one of a respective additional identifier and a respective additional numerical value and disposed in at least one additional first and additional second subgroups, the at least one additional first and additional second subgroups associated with respective additional market characteristics distinct from the first and second market characteristics, the additional entries of the additional first and additional subgroups being disposed substantially contiguously and sharing respective additional first and additional second common visual characteristics associated with each additional first and additional second subgroups.

11. The investment visualization tool of claim 1, wherein the first and second entries are interactive, further comprising a filtering window configured for receiving input regarding a condition for a value of at least one of the first and second entries.

12. The investment visualization tool of claim 1, further comprising an interactive slidable element disposed along a linear path between a first end and a second end, wherein the visual characteristics of each of the first and second entries are selectively alterable based on the position of the slidable element along the linear path.

13. The investment visualization tool of claim 1, further comprising a third group representative of a listing of top holdings, the third group comprising a plurality of third entries each displaying a respective third identifier and a respective third numerical value, the third entries disposed substantially contiguously and spaced from the first and second groups, the third entries sharing a third common visual characteristic distinct from the first and second common visual characteristics.

14. The investment visualization tool of claim 1, further comprising a third group representative of a listing of aggregate underlying holdings, the third group comprising a plurality of third entries each displaying a respective third identifier and a respective third numerical value, the third entries disposed substantially contiguously and spaced from the first and second groups, the third entries sharing a third common visual characteristic distinct from the first and second common visual characteristics.

15. A method for visualizing a financial instrument, comprising:
obtaining an indication of the financial instrument;
obtaining information relating to a composition of the financial instrument;
subdividing the information into a plurality of groups associated with respective asset classes;
subdividing the information of each group into a plurality of subgroups associated with respective market characteristics; and
displaying a plurality of entries within the groups and the subgroups, each of the entries displaying at least part of the information, the entries of each subgroup being disposed substantially contiguously within their respective one of the plurality of subgroups, sharing a respective common visual characteristic associated with their respective one of the plurality of subgroups, and relating to components of the investment tool which belong to their respective asset class.

16. The method of claim 15, wherein subdividing the information into a plurality of groups comprises subdividing the information into at least a first asset class associated with fixed income assets and a second asset class associated with equity assets.

17. The method of claim 15, wherein at least some of the first subgroups and second subgroups are associated with common market characteristics.

18. A system for visualizing a financial instrument, comprising:
a processing unit; and
a non-transitory computer-readable medium having stored thereon computer-readable instructions executable by the processing unit for:
obtaining an indication of the financial instrument;
obtaining information relating to a composition of the financial instrument;
subdividing the information into a plurality of groups associated with respective asset classes;
subdividing the information of each group into a plurality of subgroups associated with respective market characteristics; and
displaying a plurality of entries within the groups and the subgroups, each of the entries displaying at least part of the information, the entries of each subgroup being disposed substantially contiguously within their respective one of the plurality of subgroups, sharing a respective common visual characteristic associated with their respective one of the plurality of subgroups, and relating to components of the investment tool which belong to their respective asset class.

19. An investment visualization tool, comprising:
a group of a plurality of entries associated with an asset class, the group comprising:
at least two subgroups associated with respective market characteristics; and
the plurality of entries graphically represented within the first group and each sharing a respective common visual characteristic based on an associated one of the at least two subgroups and being disposed substantially contiguously therein, wherein each of the plurality of entries displays a respective identifier and/or a respective numerical value.

20. A method for searching for a financial instrument, comprising:
obtaining an indication of a selected entry, the entry belonging to a group associated with an asset class and to a subgroup associated with a market characteristic;
obtaining a condition for a value of the entry, the value related to the market characteristic;
filtering a list of a plurality of financial instruments to select at least one of the financial instruments which satisfies the condition; and
displaying a filtered list consisting of the at least one selected financial instruments.
